(19) United States
(12) Patent Application Publication
(10) Pub. No.: US 2015/0368434 A1
(43) Pub. Date: Dec. 24, 2015

(54) ORGANIC COLORANTS AND COLOURED POLYMER COMPOSITIONS WITH GOOD PROCESSING PROPERTIES

(71) Applicant: BAYER MATERIALSCIENCE AG, Leverkusen (DE)

(72) Inventors: Alexander Meyer, Düsseldorf (DE); Joerg REICHENAUER, Krefeld (DE)

(21) Appl. No.: 14/654,293

(22) PCT Filed: Dec. 18, 2013
(86) PCT No.: PCT/EP2013/077043

§ 371 Date: Jun. 19, 2015

(30) Foreign Application Priority Data
Dec. 20, 2012 (EP) 12198354.8

(51) Int. Cl. C08K 5/521; C08K 5/00; C08K 5/3465; C08K 5/18; C08K 5/3417; C08K 5/08; C08K 3/00

(52) U.S. Cl. CPC C08K 5/521; C08K 5/08; C08K 5/005; C08K 3/0041; C08K 5/18; C08K 5/3417; C08K 5/3465

(57) ABSTRACT

The present invention relates to coloured moulding compounds on the basis of polycarbonate. The invention particularly relates to polycarbonate compositions containing special organic colorants with high colour stability against weathering as a result of using special stabilisers on the basis of phosphate. The invention further relates to a polymer composition containing at least one thermoplastic substance, at least one organic colorant, preferably a combination of at least two organic colorants of special structure, and at least one stabiliser on the basis of phosphate. The invention further relates to the use of the colorant/stabiliser combination of the invention to colour polymer compositions, in particular for transparent uses, as required for producing panels for use in buildings, motor vehicles, rail vehicles or aircraft.

The present invention relates to colored molding compositions based on polycarbonate. In particular, the present invention relates to polycarbonate compositions containing specific organic colorants having high color stability against weathering using specific stabilizers based on phosphate.

The invention further relates to a polymer composition containing at least one thermoplastic polymer, at least one organic colorant, preferably a combination of at least two organic colorants having a specific structure, and also at least one stabilizer based on phosphate.

The invention further relates to the use of the colorant/stabilizer combination according to the invention for coloring polymer compositions, in particular for transparent formulations as are required for production of panes for use in buildings, motor vehicles and rail vehicles or aircraft.

In an alternative embodiment, the invention relates to opaquely colored moldings.

For the purposes of the present invention, transparency means that the background can clearly be discerned when looking through the transparent material, e.g. in the form of an appropriate molding. Simple light transmittance as, for example, in the case of translucent glass through which the background does not appear sharp is insufficient for the material in question to be referred to as transparent. Transparent thermoplastic polymers and the thermoplastic polymer compositions for the purposes of the present invention also have an initial haze of less than 5.0%, preferably 4.0%, more preferably less than 3.0%, particularly preferably less than 2.0%. For the purposes of the present invention, the haze is, unless indicated otherwise, determined in accordance with ASTM D 1003 using a BYK Gardner haze gard.

For the purposes of the present invention, opaquely colored refers to materials which do not meet the above-described conditions for transparency. In particular, the term refers to molding compositions which have a light transmission of less than 1%, or an L* of greater than 15.

In addition, the present invention relates to a process for producing thermoplastic polymer compositions containing the colorant-stabilizer combination of the invention.

The present invention additionally relates to the moldings or shaped objects produced as products from the colored thermoplastic polymer compositions of the invention.

The coloring of plastics is known per se. Nevertheless, there has hitherto been a lack of colorant combinations, in particular for transparent formulations, which have excellent weathering stability for applications having demanding optical requirements combined with good processing stability. Applications having such demanding requirements in respect of the colorant combinations used include, inter alia, transparent finished parts for automobile windows which can be colored in different ways depending on the application. Owing to the long life of motor vehicles, it is important, in particular in the field of high-priced automobiles, that the desired high-quality color impression of the material is retained over the period of the useful life without appreciable deterioration.

Owing to the requirements mentioned, the number of suitable weathering-stable colorants is limited.

Owing to the long required life, glass is frequently used as window material. Glass is insensitive to UV radiation, has a low susceptibility to scratching and its mechanical properties do not alter over long periods of time. Since inorganic oxides, e.g. iron oxide, are used as pigments, the color properties remain virtually unchanged. However, it is not possible to use these pigments in thermoplastic materials since they lead to haze and/or degradation of the corresponding matrix.

However, windows made of compositions containing transparent thermoplastic polymers such as polycarbonate offer many advantages over conventional glass windows for use in the vehicle sector and for buildings. These include, for example, increased resistance to breakage and/or weight saving, which in the case of automobile windows make greater passenger safety in the case of traffic accidents and a lower fuel consumption possible. Finally, transparent materials containing transparent thermoplastic polymers allow a significantly greater design freedom because of the greater ease of shaping.

Owing to the abovementioned advantages of plastics, there is therefore a need for materials which have both the good physical properties of thermoplastics and also the high color stability corresponding to colored glasses.

Among transparent thermoplastic polymers, polymers based on polycarbonate and polymethyl methacrylate (PMMA), for example, are particularly suitable for use as window material. Owing to the high toughness, polycarbonate in particular has a very good property profile for such uses and is preferred for the purposes of the present invention.

In order to improve the life of thermoplastic materials, it is known that they can be provided with UV protection and/or scratch-resistant coatings.

As indicated above, the number of colorants which have an extremely high weathering stability is limited. It has surprisingly been found that specific colorants are extremely stable to weathering but display a color shift during processing, i.e. in a compounding, extrusion or injection-molding process. This color shift is undesirable and considerably impairs the optical properties of the respective molding. It was surprising that the discoloration becomes clearly noticeable especially during processing of polycarbonate having high molar masses or high viscosities, sometimes in combination with high processing temperatures. At low viscosities or low temperatures, this effect is less pronounced or not discernible. However, since the material is frequently subjected to a high temperature in extruders or injection-molding machines, here especially in hot channels, during processing of the thermoplastic composition, a heat-stable composition is not only advantageous but also essential. More highly viscous materials and materials having a relatively high heat distortion temperature or relatively high glass transition temperature require higher processing temperatures at which, as indicated above, the risk of a color shift exists or increases.

It is therefore desirable for the polycarbonate composition to be able to be processed at the temperatures customary for thermoplastics without the color or the other properties, e.g. mechanical properties, changing significantly during processing.

It was therefore an object of the invention to provide polycarbonate compositions containing colorants, or colorant combinations in combination with suitable stabilizers, which have a high weathering stability and high color stability at high processing temperature as occurs, for example, in the case of polymers having high molecular weights and high viscosities or having high glass transition temperatures. The composition should also display an excellent melt stability.

It was a further object of the present invention to provide a process for producing thermoplastic polymer compositions containing the organic colorant-stabilizer combination according to the invention.

Furthermore, it was an object of the present invention to provide colored thermoplastic polymer compositions containing at least one organic colorant and at least one stabilizer for the production of multilayer articles, moldings and finished parts.

The object has surprisingly been able to be achieved by the inventive organic colorant combinations containing specific stabilizers and the thermoplastic polymer compositions of the invention produced using the organic colorant-stabilizer combination according to the invention.

It has been found that the phosphorus-based additives such as phosphites or phenolic antioxidants which are customarily used for stabilizing polycarbonate had little effectiveness or are ineffective in respect of the processing stabilization or long-term stabilization of the colorants.

There is no information in the known prior art about how colorants in a polycarbonate matrix can be stabilized both for processing and also over the time of use.

While colorants which are not according to the invention and have a similar structure and similar color characteristics as the colorants which are suitable according to the invention are processing-stable and require no further stabilization, it has been found that these colorants surprisingly do not meet the demanding requirements in respect of weathering stability.

Colorants having a high light fastness and high stability to weathering are described, for example, in WO 2012080398. However, this publication does not disclose how the corresponding colored mixtures behave at high processing temperatures and how the compositions can be stabilized against changes caused by heat.

EP 2 305 748 and WO 2009/100828 describe polycarbonate compositions containing phosphines and/or phosphates as stabilizers in order to improve the physical properties of the composition, e.g. the hydrolysis stability. Specific colorant compositions are not described nor is the stabilization thereof.

U.S. Pat. No. 6,476,158 describes opaque, i.e. nontransparent polycarbonate-polyester compositions which have a particularly high weathering stability and retention of surface gloss. However, neither transparent formulations nor the stabilization of the colorants against thermal influences is described.

U.S. Pat. No. 6,355,723 describes hydroxyl-functionalized anthraquinones in polycarbonate compositions, but no information is given about the stabilization of these specific colorant systems.

EP 1 275 694 describes a large number of colorants including hydroxy-functionalized anthraquinone systems for use in polycarbonate, but no information is given about the thermal stability or weathering stability of the colorants.

In addition, a large number of stabilizers and specific phosphates are described as catalysts, but no relationship between color stability, dye and stabilizer is disclosed.

US 20100255295 and JP 2000191899 disclose a large number of dyes, including anthraquinone systems, but no indication of high weathering stability of specific colorants is given. Furthermore, a large number of stabilizers, including phosphates, are mentioned but without their suitability for stabilizing the colorants being discussed.

JP 07033969 discloses phosphonates and phosphites for stabilizing colorant mixtures, which can serve as comparative examples for the purposes of the present invention.

It is not possible to see from the prior art which colorant systems can be stabilized in what way in a polycarbonate matrix. The prior art provides no teaching as to how the problem indicated here can be solved.

Organic colorants according to the invention are the structures shown below under b), with at least one organic colorant having the structures disclosed under b) being present in the colored thermoplastic polymer compositions of the invention. The mixture preferably contains further colorants; preference is here given to, in particular, the colorants mentioned under b).

The composition of the invention based on a thermoplastic polymer component a) contains: b) at least one colorant which is based on anthraquinone and bears at least one OH function. Particularly preferred anthraquinone-based colorants having at least one OH function are selected from among the following structures 1 and 2:

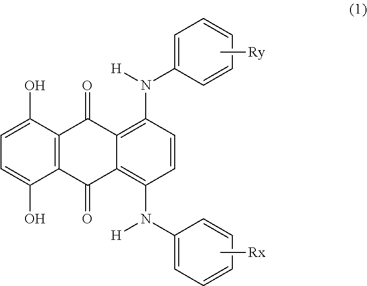

Here, Rx and Ry are each a branched or linear alkyl radical, in particular a linear or branched C1-C12 radical and particularly preferably methyl, ethyl, propyl, n-butyl, isopropyl, isobutyl, tert-butyl, pentyl, hexyl, heptyl, octyl and very particularly preferably n-butyl, tert-butyl and methyl. Such colorants are, for example, obtainable under the trade names Macrolex® Grün G (e.g. CAS No. 28198-05-2, 4851-50-7) from Lanxess AG.

For the purposes of the present invention, the notation C(number) (e.g. C1, C12) refers to a carbon chain having a chain length corresponding to the subsequent (number), with structural isomers also being encompassed.

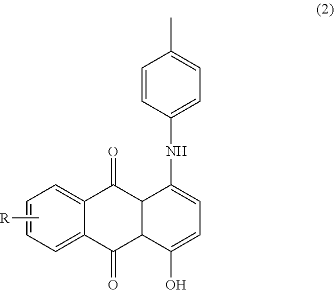

R is selected from the group consisting of H and p-methylphenylamine radical; preference is given to R═H.

Such colorants are obtainable, for example, under the trade name Macrolex® Violet B (CAS 81-48-1) from Lanxess AG.

b1) Optionally one or more further colorants, preferably colorants based on anthraquinone, based on perinone or based on phthalocyanine, selected from the group of colorants having the structures (3) to (8)

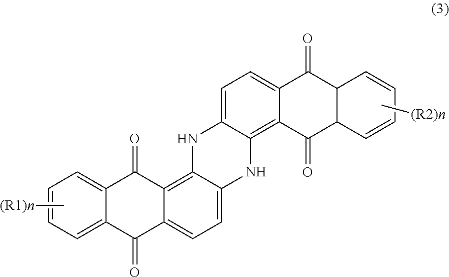

where
R1 and R2 are each, independently of one another, a linear or branched alkyl radical or halogen, preferably methyl, ethyl, propyl, isopropyl, butyl, isobutyl, tert-butyl, pentyl, neopentyl, hexyl, thexyl or Cl, more preferably methyl or Cl and particularly preferably Cl.
n is a natural number in the range from 0 to 4.

In a particularly preferred embodiment, n=0 in all rings, so that all radicals R1 and R2=H.

Colorants having this structure (3) are commercially available from the Paliogen Blue range of BASF AG.

When using colorants having the structure (3), particular preference is given to the pigments which have a poured volume (determined in accordance with DIN ISO 787-11) of 2 L/kg-10 L/kg, preferably 3 L/kg-8 L/kg, a specific surface area (determined in accordance with DIN 66132) of 5 m²/g-60 m²/g, preferably 10 m²/g-55 m²/g, and a pH (determined in accordance with DIN ISO 787-9) of 4-9.

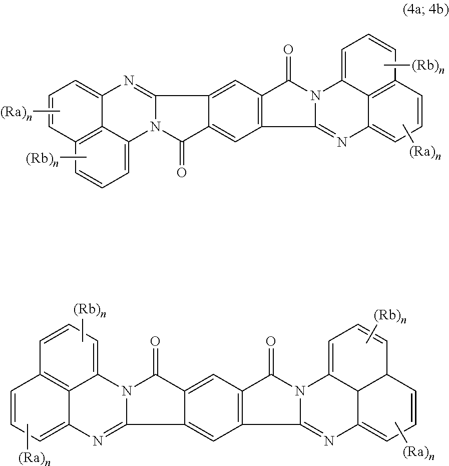

where
Ra and Rb are each, independently of one another, a linear or branched alkyl radical or halogen, preferably methyl, ethyl, propyl, isopropyl, butyl, isobutyl, tert-butyl, pentyl, neopentyl, hexyl, thexyl or Cl, more preferably methyl or Cl and particularly preferably Cl.
n is, independently of the particular radical R, a natural number in the range from 0 to 3, with the radical in the case of n=0 being hydrogen.

In a preferred embodiment, Ra and/or Rb are Cl and are located in o and/or p positions relative to the carbon atoms which bear the amine functions, e.g. diorthochloronaphthalino, di-ortho, mono-para-chloronaphthalino and mono-ortho-naphthalino. Furthermore, in a preferred embodiment, Ra and Rb are each a tert-butyl radical which is preferably present in the meta position relative to the carbon atoms which bear the nitrogen functions.

In a particularly preferred embodiment, n=0 in all rings, so that all radicals Ra and Rb═H.

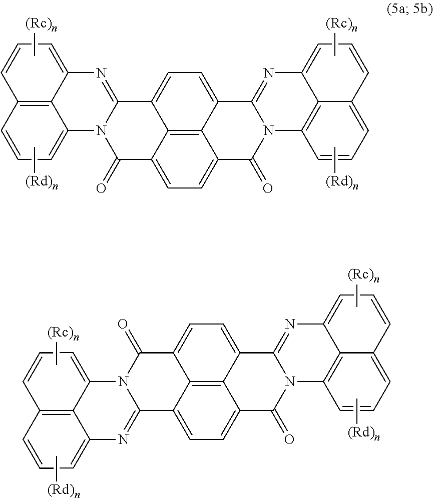

where
Rc and Rd are each, independently of one another, a linear or branched alkyl radical or halogen, preferably methyl, ethyl, propyl, isopropyl, butyl, isobutyl, tert-butyl, pentyl, neopentyl, hexyl, thexyl or Cl, more preferably methyl or Cl and particularly preferably Cl.
n is, independently of the particular radical R, a natural number in the range from 0 to 3, with the radical in the case of n=0 being hydrogen.

In a preferred embodiment, Rc and/or Rd are Cl and are present in o and/or p positions relative to the carbon atoms which bear the amine functions, e.g. diorthochloronaphthalino-, diortho, mono-para-chloronaphthalino and mono-ortho-naphthalino. Furthermore, in a preferred embodiment, Rc and Rd are each a tert-butyl radical which is preferably present in the meta position relative to the carbon atoms which bear the nitrogen functions.

In a particularly preferred embodiment, n=0 in all rings, so that all radicals Rc and Rd=H.

The structures (4a) and (4b) or (5a) and (5b) are isomeric. The respective isomers can be used alone or in a mixture. In a particular embodiment, a 1:1 isomer mixture (based on the respective amount of the isomer in the isomer mixture in % by weight) of(4a) and (4b) or (5a) and (5b) is used.

The preparation of such colorants has been described, for example, in DE 2148101 or WO 2009 074504 A1.

The composition according to the invention preferably contains at least one colorant having one of the structures (4a), (4b), (5a) and (5b), with particular preference being given among these to the colorants having the structures (4a) and (4b).

In a further embodiment, the structures (4a), (4b), (5a) and (5b) are used as pure isomers in each case; the pure isomers can be obtained, for example, by preparative HPLC.

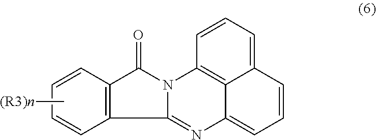

where R3 is preferably halogen, particularly preferably CL, and n is particularly preferably 4. Preference is also given to an embodiment in which n=0, so that R3=H.

Such colorants are obtainable, for example, as Macrolex® Orange 3G or Macrolex® Red EG from Lanxess AG.

When R3 is Cl and n=4, it is possible to use, instead of the colorant of the structure (6), the colorant having the structure (7) in order to achieve the same color properties:

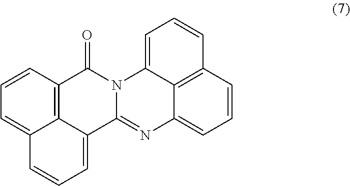 [SMILES: O=c1c2cccc3cccc(c32)c2nc3cccc4cccc(c43)n12]

Such colorants are obtainable, for example, under the trade name Macrolex® Red E2G from Lanxess AG.

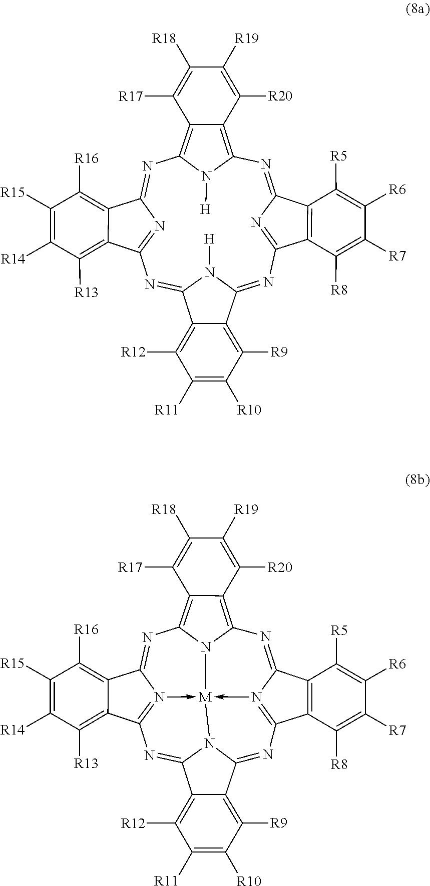

The radicals R(5-20) are, in each case independently of one another, hydrogen, methyl, ethyl, propyl, isopropyl, butyl, isobutyl, tert-butyl, pentyl, neopentyl, hexyl, thexyl, fluorine, chlorine, bromine, sulfone, CN.

R(5-20) is preferably identical in all positions. Preference is also given to R(5-20) being H in all positions. In an alternative embodiment, R(5-20) is Cl in all positions.

M is preferably aluminum (with R═H: aluminum phthalocyanine, CAS: 14154-42-8), nickel (with R═H: nickel phthalocyanine, CAS: 14055-02-8), cobalt (with R═H: cobalt phthalocyanine, CAS: 3317-67-7), iron (with R═H: iron phthalocyanine, CAS: 132-16-1), zinc (with R═H: zinc phthalocyanine CAS: 14320-04-08), copper (with R═H: copper phthalocyanine, CAS: 147-14-8; with R═H and Cl: polychlorocopper phthalocyanine, CAS: 1328-53-6; with R═Cl: hexadecachlorophthalocyanine, CAS: 28888-81-5; with R═Br: hexadecabromophthalocyanine, CAS: 28746-04-5), manganese (with R═H: manganese phthalocyanine, CAS: 14325-24-7).

Particular preference is given to the combination of M=Cu and R═H for all positions. A compound of the structure (8b) with M=Cu and R(5-20)=H is obtainable as Heliogen® Blau K 6911D or Heliogen® Blau K 7104 KW from BASF AG, Ludwigshafen.

Compounds of the structure (Sa) are obtainable, for example, as Heliogen® Blau L 7460 from BASF AG, Ludwigshafen.

The organic colorants disclosed as components b) and b1) in the context of the present invention are used in amounts, based on the respective individual component, of from 0.000001% by weight to 1.000000/o by weight, preferably from 0.00005% by weight to 0.50000% by weight and particularly preferably from 0.0001% by weight to 0.1000% by weight, in thermoplastic polymer compositions.

In a specific embodiment of transparently colored thermoplastic polymer compositions, the organic colorants according to the invention are used in amounts, based on the respective individual component, of from 0.00001% by weight to 0.30000% by weight, preferably from 0.00005% by weight to 0.10000% by weight and particularly preferably from 0.00010% by weight to 0.05000% by weight, in the thermoplastic polymer compositions.

The amount in % by weight are here based on a resulting polymer composition containing the inventive organic colorants or organic colorant combinations.

In a preferred embodiment, the colorant compositions of the invention necessarily contain at least one colorant selected from the component b1).

The thermoplastic polymer compositions of the invention containing the organic colorants or organic colorant combinations of the invention are here particularly preferably based on polycarbonate.

c)

at least one stabilizer or processing aid based on phosphate. The phosphate has the following structure (9)

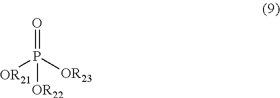

where R21 to R23 can be H or identical or different linear, branched or cyclic alkyl radicals. Particular preference is given to C1-C18 alkyl radicals. C1-C18-Alkyl is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,22-trimethylpropyl, 1-ethyl-1-methylpropyl, 1-ethyl-2-methylpropyl or 1-ethyl-2-methylpropyl, n-heptyl and n-octyl, pinacyl, adamantyl, the isomeric menthyls, n-nonyl, n-decyl, n-dodecyl, n-tridecyl, n-tetradecyl, n-hexadecyl or n-octadecyl.

Alkyl phosphates which are suitable for the purposes of the invention are, for example, monohexyl, dihexyl and trihexyl phosphate, triisoctyl phosphate and trinonyl phosphate.

Triisooctyl phosphate (tris-2-ethylhexyl phosphate) is preferably used as alkyl phosphate. Mixtures of various monoalkyl, dialkyl and trialkyl phosphates can also be used.

The alkyl phosphates used are preferably employed in amounts of less than 0.0500% by weight, preferably from 0.00005% by weight to 0.05000% by weight, particularly preferably from 0.0002 to 0.0500% by weight, very particularly preferably from 0.0005% by weight to 0.0300% by weight and in a very particular case from 0.001 to 0.0120, based on the total weight of the composition.
d)

optionally from 0.0% by weight to 1.0% by weight, preferably from 0.01% by weight to 0.50% by weight, particularly preferably from 0.01% by weight to 0.40% by weight, of one or more mold release agents, based on the total weight of the composition. Particularly suitable mold release agents for the composition of the invention are pentaerythrityl tetrastearate (PETS) or glyceryl monostearate (GMS), preferably PETS

e)

optionally from 0.00% by weight to 20.00% by weight, preferably from 0.05% by weight to 10.00% by weight, more preferably from 0.10% by weight to 1.00%6 by weight, even more preferably from 0.10% by weight to 0.50% by weight and very particularly preferably from 0.10% by weight to 0.30% by weight, of at least one UV (ultraviolet) absorber.

Suitable UV absorbers are, for example, described in EP 1 308 084 A1, DE 102007011069 A1 and DE 10311063 A1. Particularly suitable ultraviolet absorbers are hydroxybenzotriazoles such as 2-(3′,5′-bis-(1,1-dimethylbenzyl)-2′-hydroxyphenyl)benzotriazole (Tinuvin® 234, BASF AG, Ludwigshafen), 2-(2′-hydroxy-5′-(tert-octyl)phenyl)benzotriazole (Tinuvin® 329, BASF AG, Ludwigshafen), 2-(2′-hydroxy-3′-(2-butyl)-5′-(tert-butyl)phenyl)benzotriazole (Tinuvin® 350, BASF AG, Ludwigshafen), bis-(3-(2H-benzotriazolyl)-2-hydroxy-5-tert-octyl)methane (Tinuvin® 360, BASF AG, Ludwigshafen), (2-(4,6-diphenyl-1,3,5-triazin-2-yl)-5-(hexyloxy)phenol (Tinuvin® 1577, BASF AG, Ludwigshafen), and the benzophenones 2,4-dihydroxybenzophenone (Chimasorb® 22, BASF AG, Ludwigshafen) and 2-hydroxy-4-(octyloxy)benzophenone (Chimassorb® 81, Ciba, Basel), 2-propenoic acid, 1,3-propanediyl 2-cyano-3,3-diphenyl-, 2,2-bis[[(2-cyano-1-oxo-3,3-diphenyl-2-propenyl)oxy]methyl]ester (9C1) (Uvinul® 3030, BASF AG Ludwigshafen), 2-[2-hydroxy-4-(2-ethylhexyl)oxy]phenyl-4,6-di(4-phenyl)phenyl-1,3,5-triazine (Tinuvin® 1600, BASF AG, Ludwigshafen) or tetraethyl-2,2′-(1,4-phenylenedimethyl-idene)bismalonate (Hostavin B-Cap, Clariant AG). It is also possible to use mixtures of these ultraviolet absorbers.

f)

optionally 0.00% by weight—0.20% by weight, preferably 0.01% by weight—0.10% by weight, more preferably from 0.01% by weight to 0.05% by weight, particularly preferably from 0.015% by weight to 0.040% by weight, of one or more thermal or processing stabilizers, different from c), based on the weight of the total composition, preferably selected from the group consisting of phosphines, phosphites and phenolic antioxidants and also mixtures thereof.

Suitable stabilizers are triphenyl phosphite, diphenyl alkyl phosphite, phenyl dialkyl phosphite, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,4-dicumylphenyl) pentaerythritol diphosphite, bis(2,6-di-tert-butyl-4-mcthylphenyl) pentaerythritol diphosphite, diisodecyloxy pentaerythritol diphosphite, bis(2,4-di-tert-butyl-6-methylphenyl) pentaerythritol diphosphite, bis(2,4,6-tris(tert-butylphenyl) pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenzo[d,g]-1,3,2-dioxaphosphocin, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyldibenzo[d,g]-1,3,2-dioxaphosphocin, 2,2′,2″-nitrilo[triethyl tris(3,3′,5,5′-tetra-tert-butyl-1,1′-biphenyl-2,2′-diyl)phosphite], 2-ethylhexyl 3,3′,5,5′-tetra-tert-butyl-1,1″-biphenyl-2,2′-diyl) phosphite, 5-butyl-5-ethyl-2-(2,4,6-tri-tert-butylphenoxy)-1,3,2-dioxaphosphirane, bis(2,6-di-tert-butyl-4-methylphenyl) pentaerythritol diphosphite, triphenylphosphine (TPP), trialkylphenyl phosphine, bis(diphenylphosphino)ethane or a trinaphthyl phosphine.

Particular preference is given to using triphenylphosphine (TPP), Irgafos® 168 (tris(2,4-di-tert-butylphenyl) phosphite) and tris(nonylphenyl) phosphate or mixtures thereof.

Furthermore, it is possible to use phenolic antioxidants such as alkylated monophenols, alkylated thioalkylphenols, hydroquinones and alkylated hydroquinones. Particular preference is given to using Irganox® 1010 (pentaerythrityl 3-(4-hydroxy-3,5-di-tert-butylphenyl)propionate; CAS: 6683-19-8) and Irganox 10766 (2,6-di-tert-butyl-4-(octadecanoxycarbonylethyl)phenol).

Component g): the polycarbonate composition of the invention can optionally contain from 0.0% by weight to 5.0% by weight, preferably from 0.01% by weight to 1.00% by weight, of further additives. The further additives are conventional polymer additives, e.g. the flame retardants, optical brighteners, flow improvers, thermal stabilizers, inorganic pigments, mold release agents or processing aids described in EP-A 0 839 623, WO-A 96/15102, EP-A 0 500 496 or “Plastics Additives Handbook”, Hans Zweifel, 5th edition 2000, Hanser Verlag, Munich.

The composition optionally contains a nanosize pigment, preferably carbon black, as additive. The carbon black is preferably present finely dispersed in the organic polymer matrix. Suitable carbon blacks preferably have an average particle size of less than 100 nanometers (nm), more preferably less than 75 nm, even more preferably less than 50 nm and particularly preferably less than 40 nm, with the average particle size preferably being greater than 0.5 nm, more preferably greater than 1 nm and particularly preferably greater than 5 nm.

Carbon blacks which are suitable for the purposes of the invention differ from conductive carbon blacks in that they have only a low electrical conductivity or no electrical conductivity. Compared to the carbon blacks used here, conductive carbon blacks have particular morphologies and long-range structures in order to achieve a high conductivity. In comparison, the nanosize carbon blacks used here can be dispersed very readily in thermoplastics, so that there are barely any contiguous regions composed of carbon black from which a corresponding conductivity could result. Commercially available carbon blacks which are suitable for the purposes of the invention are obtainable under many trade names and in many forms, e.g. pellets or powder. Thus, suitable carbon blacks are obtainable under the trade names BLACK PEARLS®, as wet-processed pellets under the name ELFTEX®, REGAL® and CSX®, and in a floccular form under MONARCH®, ELFTEX®, REGAL® and MOGUL®—all from Cabot Corporation.

In a particularly preferred embodiment, the carbon black types have particle sizes of 10-30 nm and preferably have a surface area of 35-138 m² per g (m²/g). The carbon black can have been treated or be untreated; thus, the carbon black can have been treated with particular gases, with silica or organic substances such as butyllithium. Such a treatment makes it possible to achieve modification or functionalization of the surface. This can improve the compatibility with the matrix used.

Particular preference is given to carbon blacks which are marketed under the trade name BLACK PEARLS® (CAS No. 1333-86-4) (particle size about 17 nm).

The nanosize carbon black is preferably used in concentrations of from 0.0005% by weight—0.035% by weight in the composition of the invention.

The substances disclosed above as components b) to f) according to the present invention are in this context expressly not part of the component g).

The proportion of the thermoplastic polymer of the component a) adds up together with the proportions of the other components to 100% by weight.

The embodiments mentioned as preferred in the present invention can be present either individually or in combination with one another.

In a preferred embodiment, the composition consists of the components a, c, d, e and f, in a further preferred embodiment of the components a-f and in a particularly preferred embodiment of the components a-g.

The Polymer Component a) Contains:

a thermoplastic polymer, preferably a transparent thermoplastic polymer, preferably polycarbonate, copolycarbonate, polyester carbonate, polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), cyclic polyolefin, polyacrylates or copolyacrylates and polymethacrylate or copolymethacrylate, e.g. polymethyl or copolymethyl methacrylates (such as PMMA) and also copolymers with styrene, e.g. transparent polystyrene-acrylonitrile (PSAN), thermoplastic polyurethanes, polymers based on cyclic olefins (e.g. TOPAS®, a commercial product from Ticona), more preferably polycarbonate, copolycarbonate, polyester carbonate, aromatic polyesters or polymethyl methacrylate, or mixtures of the components mentioned, and particularly preferably polycarbonate and copolycarbonate, with the transparent thermoplastic polymer being added in such amounts that it together with all other components adds up to 100% by weight.

Mixtures of a plurality of transparent thermoplastic polymers are also possible, especially when they are miscible with one another to give a transparent mixture; in a specific embodiment, a mixture of polycarbonate with PMMA (more preferably with PMMA<2% by weight) or polyester is preferred.

In this context, a further specific embodiment contains a mixture of polycarbonate and PMMA in an amount of less than 2.0%, preferably less than 1.0%, more preferably less than 0.5%, with at least 0.01% of PMMA being present based on the amount of polycarbonate, where the PMMA preferably has a molecular weight of <40 000 g/mol. In a particularly preferred embodiment, the proportion of PMMA is 0.2% and particularly preferably 0.1%, based on the amount of polycarbonate, where the PMMA preferably has a molecular weight of <40 000 g/mol.

An alternative further specific embodiment contains a mixture of PMMA and polycarbonate comprising less than 2%, preferably less than 1%, more preferably less than 0.5%, even more preferably 0.2% and particularly preferably 0.1%, of polycarbonate based on the amount of PMMA.

Suitable polycarbonates for producing the polymer composition of the invention are all known polycarbonates. These are homopolycarbonates, copolycarbonates and thermoplastic polyester carbonates.

The suitable polycarbonates preferably have average molecular weights M̅_{w} of from 10 000 to 50 000, preferably from 14 000 to 40 000 and in particular from 16 000 to 32 000, determined by gel permeation chromatography with polycarbonate calibration. The polycarbonates are preferably prepared by the phase interface process or the melt transesterification process, which have been described many times in the literature.

As regards the phase interface process, reference may be made by way of example to H. Schnell, “Chemistry and Physics of Polycarbonates”, Polymer Reviews, vol. 9, Interscience Publishers, New York 1964 p. 33 ff., to Polymer Reviews, vol. 10, “Condensation Polymers by interfacial and Solution Methods”, Paul W. Morgan, Interscience Publishers, New York 1965, chapter VIII, p. 325, to Dres. U. Grigo, K. Kircher and P. R- Müller “Polycarbonate” in Becker/Braun, Kunststoff-Handbuch, volume 3/1, Polycarbonate, Polyacetale, Polyester, Celluloseester, Carl Hlanser Verlag, Munich, Vienna 1992, pp. 118-145, and to EP 0 517 044 A1.

The melt transesterification process is described, for example, in Encyclopedia of Polymer Science, vol. 10 (1969), Chemistry and Physics of Polycarbonates, Polymer Reviews, H. Schnell, vol. 9, John Wiley and Sons, Inc. (1964) and in the patent documents DE-B 10 31 512 and U.S. Pat. No. 6,228,973.

The polycarbonates are preferably prepared by reactions of bisphenol compounds with carbonic acid compounds, in particular phosgene or in the melt transesterification process diphenyl carbonate or dimethyl carbonate.

Here, particular preference is given to homopolycarbonates based on bisphenol A and copolycarbonates based on the monomers bisphenol A and 1,1-bis(4-hydroxyphenyl)-3,3,5-trimethylcyclohexane.

These and further bisphenol and diol compounds which can be used for the polycarbonate synthesis are disclosed, inter alia, in WO 2008037364 A1 (p. 7, line 21 to p. 10, line 5), EP 1 582 549 A1 ([0018] to [0034]), WO 2002026862 A1 (p. 2, line 20 to p. 5, line 14), WO2005113639 A1 (p. 2, line 1 to p. 7, line 20).

The polycarbonates can be linear or branched. It is also possible to use mixtures of branched and unbranched polycarbonates.

Suitable branching agents for polycarbonates are known from the literature and described, for example, in the patent documents U.S. Pat. No. 4,185,009 and DE 25 00 092 A1 (3,3-bis(4-hydroxyaryloxindole according to the invention, see in each case the entire document), DE 4240 313 A1 (see p. 3, lines 33 to 55), DE 19 943 642 A1 (see p. 5, lines 25 to 34) and U.S. Pat. No. 5,367,044 and the literature cited therein.

In addition, the polycarbonates used can also be intrinsically branched, in which case no branching agent is added during the preparation of the polycarbonate. An example of intrinsic branching is Fries structures as are disclosed for melt polycarbonates in EP 1 506 249 A1.

Furthermore, chain terminators can be used in the preparation of the polycarbonate. As chain terminators, preference is given to using phenols such as phenol, alkylphenols such as cresol and 4-tert-butylphenol, chlorophenol, bromophenol, cumylphenol or mixtures thereof.

In a preferred embodiment, polycarbonate or copolycarbonate based on 1,1-bis(4-hydroxyphenyl)-3,3,5-trimethylcyclohexane (APEC® from Bayer MaterialScience, Leverkusen) is used as thermoplastic polymer or copolymer or constituent of a mixture of thermoplastic polymers.

The viscosity of the thermoplastic polymer is preferably in the MVR range from 38 to 4, more preferably from 20 to 6 and particularly preferably from 14 to 8.

The thermoplastic polymer compositions of the invention based on the polymer component can contain not only the organic colorants or organic colorant combinations according to the invention of the components b) and b1) and the stabilizer c) and components d), e) and f) according to the invention but optionally also the further component g). Such components include, for example, IR absorbers:

The polycarbonate composition of the invention can optionally contain from 0.000% by weight to 0.015% by weight, preferably from 0.00150% by weight to 0.01500%, more preferably from 0.00180% by weight to 0.01100%/o by weight and particularly preferably from 0.00200% by weight to 0.00900% by weight, of at least one organic or inorganic IR absorber calculated as solids proportion of IR absorbers in the total polymer composition. In a specific embodiment, the IR absorbers are used in an amount of preferably from 0.00350% by weight to 0.00850% by weight and particularly preferably from 0.00400% by weight to 0.00800% by weight, calculated as solids proportion of IR absorbers in the total polymer composition. In this context, solids proportion of IR absorbers means the ER absorber as pure substance and not a suspension or other preparation containing the pure substance.

Suitable IR absorbers are disclosed in, for example, EP 1 559 743 A1, EP 1 865 027A1, DE 10022037 A1, DE 10006208 A1 and in the Italian patent applications RM2010A000225, RM2010A000227 and RM2010A000228.

Among the IR absorbers mentioned in the literature cited, preference is given to those based on boride and tungstate and also ITO- and ATO-based absorbers and combinations thereof.

The composition optionally contains from 0% by weight to 50% by weight, preferably from 0% by weight to 35% by weight, more preferably from 0% by weight to 30% by weight, particularly preferably from 10% by weight to 30% by weight, of fillers and reinforcing materials.

Fillers and reinforcing materials for polymer compositions are, for example, described in EP 1 624 012 A1, DE 3742881 A1, U.S. Pat. No. 6,860,539 B2, US 20060105053 A1, DE 102006055479 A1, WO 2005030851 A1 and WO 2008122359 A1.

The compositions of the invention are stable during processing at the processing temperatures customary for thermoplastics, i.e. at temperatures above 300° C., e.g. 350° C., without the color or the performance data changing significantly during processing.

The polymer compositions of the invention containing the components a) to h) are produced using conventional incorporation methods by combining, mixing and homogenizing, with the homogenization in particular preferably taking place in the melt under the action of shear forces. The combining and mixing optionally occurs before the melt homogenization using powder premixes.

It is also possible to use premixes which have been produced from solutions of the mixture components in suitable solvents, with homogenization optionally being carried out in solution and the solvent subsequently being removed.

In particular, the components of the composition of the invention can be introduced by known methods, inter alia as masterbatch.

The use of masterbatches and also of powder mixtures or compacted premixes is useful, in particular, for introducing the components a) to h). If desired, all the abovementioned components can be premixed.

However, premixes of colorants b) and/or b1) and any other combinations are also possible as an alternative. In all cases, in the interest of better meterability in the production of the thermoplastic polymer compositions, the abovementioned component premixes are preferably topped up with pulverulant polymer component so as to give readily handleable total volumes.

In a particular embodiment, the abovementioned components can be mixed to form a masterbatch, with mixing preferably taking place in the melt under the action of shear forces (for example in a kneader or twin-screw extruder). This process offers the advantage that the components are distributed better in the polymer matrix. To produce the masterbatch, the thermoplastic polymer which also represents the main component of the ultimate total polymer composition is preferably selected as polymer matrix.

In this context, the composition can be combined in conventional apparatuses such as screw extruders (for example twin-screw extruders, TSE), kneaders, Brabender or Banbury mills, mixed, homogenized and subsequently extruded. After extrusion, the extrudate can be cooled and broken up. It is also possible for individual components to be premixed and for the remaining starting materials then to be added individually and/or likewise in mixed form.

The polymer compositions of the invention can be processed to give products or moldings by, for example, firstly extruding the polymer compositions to give pellets as described above and processing these pellets by suitable processes to give various products or moldings in a known manner.

The compositions of the invention can, in this context, be converted by, for example, hot pressing, spinning, blow molding, deep drawing, extrusion or injection molding into products, moldings or shaped objects. The use of multilayer systems is also of interest. The application can occur simultaneously with or immediately after shaping of the base body, e.g. by coextrusion or multiple component injection molding. The application can also occur on the finally shaped base body, e.g. by lamination with a film or by coating with a solution.

Plates or moldings made up of base layer and optional covering layer/optional covering layers (multilayer systems) can be produced by (co)extrusion, direct skinning, direct coating, insert molding, back-molding of films or other suitable methods known to those skilled in the art.

Injection-molding processes are known to those skilled in the art and are described, for example, in “Handbuch Spritzgiessen”, Friedrich Johannnaber/Walter Michaeli, Munich; Vienna: Hanser, 2001, ISBN 3-446-15632-1 or “Anleitung zum Bau von Spritzgiesswerkzeugen”, Menges/Michaeli/Mohren, Munich;

Vienna: Hanser, 1999, ISBN 3-446-21258-2.

Extrusion processes are known to those skilled in the art and described, for example, for coextrusion in, inter alia, EP-A 0 110 221, EP-A 0 110 238 and EP-A 0 716 919. For details of adapter and die processes, see Johannaber/Ast:“Kunststoff-Maschinenfllhrer”, Hanser Verlag, 2000 and in Gesellschaft Kunststofftechnik: “Coextrudierte Folien und Platten: Zukunftsperspektiven, Anforderungen, Anlagen und Herstellung, Qualitätssicherung”, VDI-Verlag, 1990.

Products, moldings or shaped objects which are preferred for the purposes of the invention are windows, for example automobile windows, windows of rail vehicles and aircraft, automobile sunroofs, safety panes, roofs or glazing of buildings, LEDs, lamp coverings for the interior of vehicles and buildings, lamp coverings for the exterior sector, e.g. coverings of street lamps, visors, spectacles, extruded and solution films for displays or electric motors, also ski films, traffic light lenses, which contain the compositions of the invention. Apart from solid plates, it is also possible to use double web plates or multiweb plates. As further components of the products according to the invention, it is possible for, for example, further materials components to be present in addition to the compositions of the invention in the products according to the invention.

In a particular embodiment, the articles made of the composition of the present invention are coated. This coating serves to protect the thermoplastic material against general weathering effects (e.g. damage by sunlight) and against mechanical damage to the surface (e.g. scratching) and thus increases the stability of the correspondingly equipped articles.

It is known that polycarbonate can be protected against UV radiation by means of various coatings. These coatings usually contain UV absorbers. These layers likewise increase the scratch resistance of the corresponding article. The articles according to the present invention can bear single-layer or multilayer systems. They can be coated on one or both sides. In a preferred embodiment, the article contains an anti-scratch coating containing UV absorbers. In a particular embodiment, the multilayer product contains at least one layer containing the composition of the invention, at least one UV protection layer and optionally an anti-scratch coating.

In the case of window materials, the article bears at least one anti-scratch and/or antireflection coating on at least one side.

### EXAMPLES

The invention is illustrated below with the aid of working examples, with the methods of determination described here being employed for all corresponding parameters in the context of the present invention, unless indicated otherwise.

Light transmission (Ty):

The transmission measurements were carried out on a Lambda 900 spectrophotometer from Perkin Elmer having a photometer sphere in accordance with ISO 13468-2 (i.e. determination of the total transmission by measurement of the diffuse transmission and direct transmission).

The determination of the color in transmission was carried out using a Lambda 900 spectrophotometer from Perkin Elmer having a photometer sphere by a method based on ASTM E1348 using the weighting factors and formulae described in ASTM E308.

The calculation of the CIELAB color coordinates L*, a*, b* is carried out for light type D 65 and 10° normal observer.

Color Change:

ΔE is a calculated value for the perceived color difference in accordance with ASTM D 2244. In the case of the present experiments, light type D 65/10° was used. The formula 7 in ASTM D 2244 was employed for calculation of the AE value.

The determination of the viscosity as MVR is carried out at 300° C. under a load of 1.2 kg in accordance with ISO 1033.

Materials for Producing the Test Specimens:

### Component b)

As anthraquinone-based colorant of the formula (1), Macrolex Griln G (Solvent Green 28; CAS 28198-05-2) from Lanxess AG, Leverkusen, with R=t-butyl is used.
As anthraquinone-based colorant of the formula (2), Macrolex Violet B (Solvent Violet 13, CAS 81-48-1) with R═H from Lanxess AG, Leverkusen, is used.
As anthraquinone-based colorant which is not according to the invention, Macrolex Grün 5B (Solvent Green 3; CAS 128-80-3) from Lanxess AG, Leverkusen, is used.
As anthraquinone-based colorant which is not according to the invention, Macrolex Violet 3R (Solvent Violet 36; CAS 61951-89-1) from Lanxess AG, Leverkusen, is used.

### Component c)

As phosphate-based stabilizer according to the invention, triisooctyl phosphate (TOF; tris-2-ethylhexyl phosphate; CAS 78-42-2) is used;
As stabilizer which is not according to the invention, triphenylphosphine (TPP) (CAS 603-35-0) is used.
As stabilizer which is not according to the invention, Irgafos PEP-Q (CAS 119345-01-6) is used.
As stabilizer which is not according to the invention, Irganox B900 (mixture of Irgafos 168 (80%) and Irganox 1076 (20%); Irgafos 168 (tris(2,4-di-tert-butylphenyl) phosphite; CAS 31570-04-4); Irganox 1076 (octadecyl 3-(3,5-di-tert-butyl-4-hydroxyphenyl)propionate; is used.
As stabilizer which is not according to the invention, Doverphos S 9228 (bis(2,4-dicumylphenyl) pentaerythritol diphosphite (CAS 154862-43-8)) is used.

As polymer component, linear bisphenol A polycarbonate having end groups based on phenol and having a melt volume rate (MVR) of 9.5 cm³/10 min, measured at 300° C. under a load of 1.2 kg in accordance with ISO 1033 [PC-A], is used. This polycarbonate does not contain any additives.

Furthermore, linear bisphenol A polycarbonate having end groups based on tert-butylphenol and having a melt volume rate (MVR) of 17 cm³/10 min, measured at 250° C. under a load of 2.16 kg in accordance with ISO 1033, is used as polymer component. This polycarbonate contains a mold release agent but no thermal stabilizer (Makrolon OD 2015 from Bayer Materialscience AG).

Production of the Thermoplastic Polymer Compositions and Production of the Injection-Molded Bodies:

The pellets are dried at 120° C. for 3 hours under reduced pressure.

The compounds and the injection-molded bodies were produced on a mini extruder and micro-injection-molding machine from DSM (DSM-Mini Extruder Midi 2000 and DSM Research Micro Injection Molding Machine, DSM; 6401 JH Heerlen (NL)); the moldings have a circular geometry (round plate) and have a diameter of 20 mm and a thickness of 1.6 mm. The temperature during extrusion is indicated below.

TABLE 1
colorant compositions (amounts in % by weight); base composition
without stabilizer

| Starting | | | | |
|---|---|---|---|---|
| material | Ex. 1 | Ex. 2 | Ex. 3 | Ex. 4 |
| PC-A | 99.99 | 99.99 | 99.99 | 99.99 |
| Macrolex | 0.01 | — | — | — |
| Violet B | | | | |
| Macrolex | — | 0.01 | — | — |
| Violet 3R | | | | |
| Macrolex | — | — | 0.01 | — |
| Grun G | | | | |
| Macrolex | — | — | — | 0.01 |
| Grun 5B | | | | |

The compositions of examples 1 to 4 are processed at a temperature of 300° C. and a residence time of 5 minutes using the above-described equipment to give circular injection-molded bodies (see above).

TABLE 2
colorant compositions containing various stabilizers (amounts in % by weight)

| Starting | | | | | | | | | | | | |
|---|---|---|---|---|---|---|---|---|---|---|---|---|
| material | Ex. 5 | Ex. 6 | Ex. 7 | Ex. 8 | Ex. 9 | Ex. 10 | Ex. 11 | Ex. 12 | Ex. 13 | Ex. 14 | Ex. 15 | Ex. 16 |
| PC A | 99.99 | 99.99 | 99.98 | 99.98 | 99.94 | 99.94 | 99.94 | 99.94 | 99.94 | 99.94 | 99.94 | 99.94 |
| Macrolex | 0.01 | — | 0.01 | — | 0.01 | — | 0.01 | — | 0.01 | — | 0.01 | — |
| Violet B | | | | | | | | | | | | |
| Macrolex | — | 0.01 | — | 0.01 | — | 0.01 | — | 0.01 | — | 0.01 | — | 0.01 |
| Grün G | | | | | | | | | | | | |
| TOF | — | — | 0.01 | 0.01 | — | — | — | — | — | — | — | — |
| Irganox | — | — | — | — | 0.05 | 0.05 | — | — | — | — | — | — |
| B 900 | | | | | | | | | | | | |
| TPP | — | — | — | — | — | — | 0.05 | 0.05 | — | — | — | — |
| Irgafos | — | — | — | — | — | — | — | — | 0.05 | 0.05 | — | — |
| PEP-Q | | | | | | | | | | | | |
| Doverphos | — | — | — | — | — | — | — | — | — | — | 0.05 | 0.05 |
| S-9228 | | | | | | | | | | | | |

The colorant compositions of examples 5 to 16 are injection-molded at higher temperature in order to test the color stability of individual compositions. The compositions of examples 5 to 16 are processed at a temperature of 350° C. and a residence time of 5 minutes using the above-described equipment to give circular injection-molded bodies. The results (color measurements) are shown in tables 4 and 5.

TABLE 3
colorant compositions containing various stabilizers (amounts in
% by weight) (comparative colorants)

| Starting | Ex. | Ex. |
|---|---|---|
| material | 17 | 18 |
| PC A | 99.99 | 99.99 |
| Macrolex | 0.01 | — |
| Violet 3R | | |
| Macrolex | — | 0.01 |
| Grun 5B | | |
| TOF | — | — |
| Irganox B | — | — |
| 900 | | |
| TPP | — | — |
| Irgafos | — | — |
| PEP-Q | | |
| Doverphos | — | — |
| S-9228 | | |

The colorant compositions of examples 17 and 18 are injection-molded at 350° C. and a residence time of the melt of 5 minutes.

The Delta-E values are based on the formulation without stabilizers, which was produced at low temperature (300° C.).

TABLE 4
formulations using Macrolex Green G

| | | | Ex. 8 | | | | |
|---|---|---|---|---|---|---|---|
| | | | According | | | | |
| | | | to the | Ex. 10 | Ex. 12 | Ex. 14 | Ex. 16 |
| | Ex. 3 | Ex. 6 | invention | comp. | comp. | comp. | comp. |
| L* | 84.28 | 87.07 | 83.94 | 85.13 | 85.33 | 88.89 | 86.29 |
| a* | −27.06 | −5.85 | −25.65 | −15.10 | −11.72 | −12.10 | −12.06 |
| b* | 1.62 | 6.07 | 2.48 | 3.84 | 4.51 | 2.10 | 3.78 |
| Delta | 0.0 | 21.85 | 1.69 | 12.19 | 15.65 | 15.66 | 15.29 |
| E | | | | | | | |

The drastic color shift at relatively high processing temperatures (example 3 at 300° C.; example 6 at 350° C.) can be seen from example 3 and example 6 which do not contain any stabilizers.

Comparison of examples 3, 6 and 8 shows that the color shift during processing can be virtually completely prevented by the polycarbonate composition of the invention (example 8). Comparative examples 10, 12, 14 and 16 demonstrate that stabilizers which are conventionally used for PC display no or very little effect in stabilization of the colorant.

TABLE 5
formulations with Macrolex Violet B

| | | | Ex. 7 | | | | |
|---|---|---|---|---|---|---|---|
| | | | According | | | | |
| | | | to the | Ex. 9 | Ex. 11 | Ex. 13 | Ex. 15 |
| | Ex. 1 | Ex. 5 | invention | comp. | comp. | comp. | comp. |
| L* | 73.98 | 80.29 | 73.88 | 70.90 | 82.14 | 72.63 | 79.96 |
| a* | 5.31 | 9.93 | 4.61 | 11.40 | 8.54 | 7.60 | 9.41 |
| b* | −28.02 | −12.62 | −26.61 | −25.18 | −11.73 | −26.31 | −15.39 |
| Delta | 0.0 | 17.27 | 1.58 | 7.39 | 18.50 | 3.16 | 14.56 |
| E | | | | | | | |

It can be seen from example 1 (processed at 300° C.) and example 5 (processed at 350° C.), which do not contain any stabilizers, that drastic color shifts occur at relatively high processing temperatures. The composition of example 7 according to the invention shows that the color shift can be reduced significantly. In contrast, the stabilizers conventionally used for polycarbonate are ineffective or significantly less effective compared to the composition of the invention.

Formulation with comparative colorant Macrolex Green 5B

TABLE 6

| | Ex. 4 | Ex. 18 |
|---|---|---|
| L* | 78.38 | 77.66 |
| a* | −25.15 | −24.80 |
| b* | −11.88 | −9.71 |
| Delta E | 0.0 | 2.31 |

TABLE 7

| | Ex. 2 | Ex. 17 |
|---|---|---|
| L* | 79.58 | 78.50 |
| a* | 13.39 | 13.73 |
| b* | −16.95 | −17.16 |
| Delta E | 0.0 | 1.15 |

It can surprisingly be seen that the colorants Macrolex Geen 5B and Macrolex Violet 3R, although structurally similar to the abovementioned colorants according to the invention (likewise anthraquinone-based), have a significantly higher thermal stability. Stabilization is for this reason not necessary in the case of these colorants.

However, the use of the thermally stable colorants Macrolex Green 5B and Macrolex Violet 3R is not possible in corresponding applications having demanding requirements in respect of color stability (light fastness; weathering) because of the unsatisfactory weathering stability. It was surprising that, in contrast, the structurally similar colorants Macrolex Violet B and Macrolex Grtin G have a high weathering stability.

Thus, both the objective of a high processing stability and the objective of a high weathering stability can be achieved by means of the compositions of the invention.

1.-15. (canceled)

16. A polymer composition having improved color stability and comprising:
a) thermoplastic polymer in a proportion which together with the other components adds up to 100% by weight,
b) at least one colorant based on anthraquinone and having at least one free hydroxyl function in a proportion of from 0.000001% by weight to 1.000000% by weight,
c) at least one stabilizer based on phosphate and having the following structure (9) 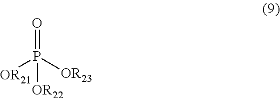
where R₂₁ to R₂₃ are H or identical or different linear, branched or cyclic alkyl radicals, where c) is present in a proportion of from 0.00005 to 0.05000% by weight.

17. The composition as claimed in claim 16, wherein the composition further comprises the following components d)-h):
d) from 0.0% by weight to 1.0% by weight of one or more mold release agents, based on the total weight of the composition,
e) from 0.0% by weight to 20.00% by weight of one or more UV absorbers, based on the total weight of the composition,
f) from 0.00% by weight to 0.20% by weight of one or more thermal or processing stabilizers different from c), based on the total weight of the composition,
g) from 0.0% by weight to 5.0% by weight of one or more further additives, based on the total weight of the composition.

18. The composition as claimed in claim 16, wherein the composition comprises components b)-h) in each case based on the total weight of the composition, in proportions of:
b) at least one colorant based on anthraquinone and having at least one free hydroxyl function in a proportion of from 0.00005% by weight to 0.50000% by weight,
c) at least one stabilizer based on phosphate in a proportion of from 0.0002% by weight to 0.0500% by weight,
d) from 0.01% by weight to 0.50% by weight of one or more mold release agents, based on the total weight of the composition,
e) from 0.05% by weight to 10.00% by weight of one or more UV absorbers, based on the total weight of the composition,
f) from 0.01% by weight to 0.05% by weight of one or more thermal or processing stabilizers different from c), based on the total weight of the composition,
g) from 0.01% by weight to 1.00% by weight of one or more further additives, based on the total weight of the composition.

19. The composition as claimed in claim 16, wherein the thermoplastic polymer is a polycarbonate.

20. The composition as claimed in claim 16, wherein the colorants are selected from the group consisting of the following structures: 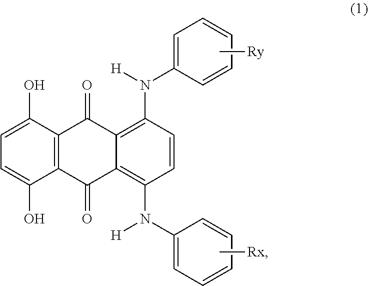
where Rx and Ry are each a branched or linear alkyl radical, 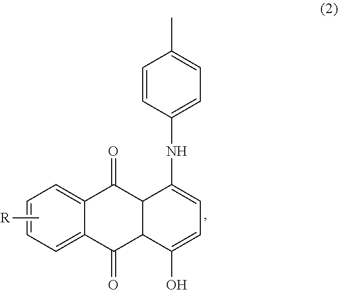
where R is selected from the group consisting of H and the p-methylphenylamine radical.

21. The composition as claimed in claim 20, wherein Rx and Ry in the formula 1 are n-butyl, tert-butyl and methyl, and R in the formula 2 is H.

22. The composition as claimed in claim 16, wherein component c) is selected from the group consisting of monohexyl, dihexyl and trihexyl phosphate, triisooctyl phosphate and trinonyl phosphate.

23. The composition as claimed in claim 16, wherein component c) is triisoctyl phosphate.

24. The composition as claimed in claim 16, wherein the composition comprises at least one further colorant of the component b1) selected from the group of colorants based on anthraquinone, based on perinone and based on phthalocyanine.

25. The composition as claimed in claim 16, wherein the composition comprises a further colorant of the component b1) selected from the group consisting of the structures (3) to (8): 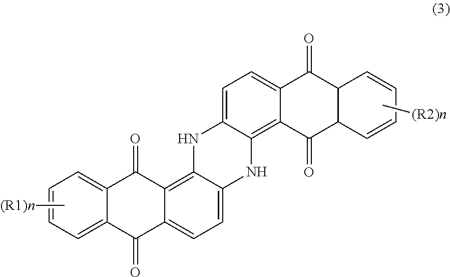
where
R1 and R2 are each, independently of one another, a linear or branched alkyl radical or halogen,
n is a natural number in the range from 0 to 4, 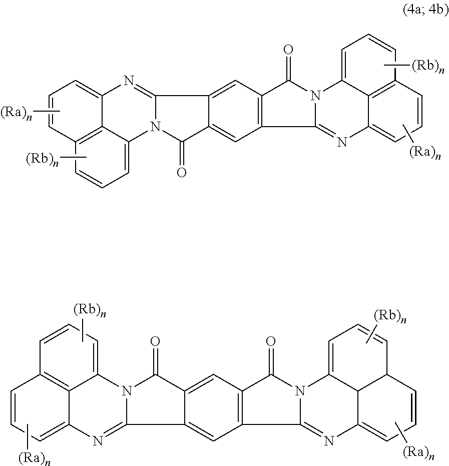
where
Ra and Rb are each, independently of one another, a linear or branched alkyl radical or halogen,
n is, independently of the respective R, a natural number in the range from 0 to 3, where the radical for n=0 is hydrogen, 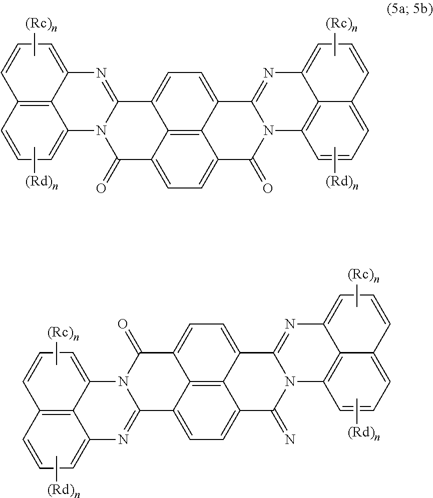
where
Rc and Rd are each, independently of one another, a linear or branched alkyl radical or halogen,
n is, independently of the respective R, a natural number in the range from 0 to 3, where the radical for n=0 is hydrogen, 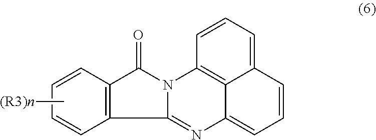
where R3 is halogen and H, 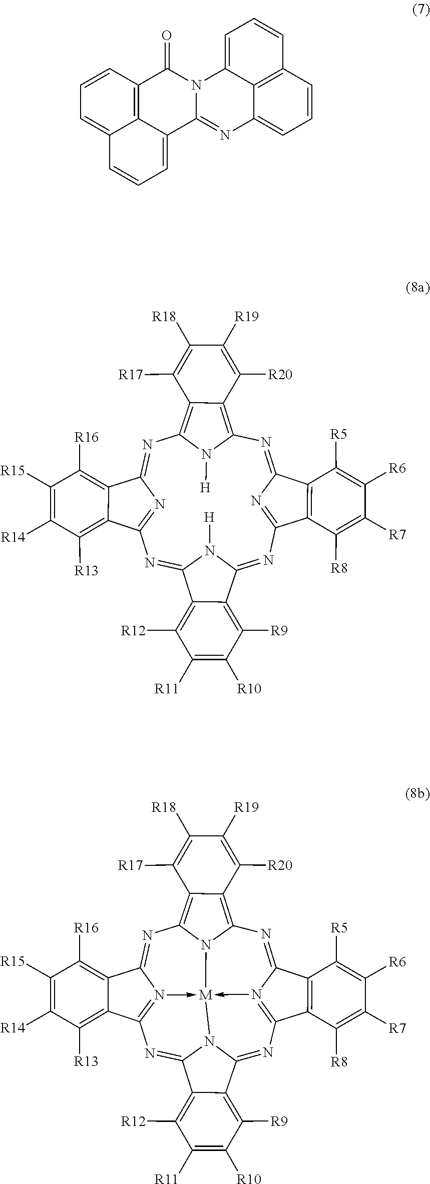
where the radicals R(5-20) are each, independently of one another, hydrogen, methyl, ethyl, propyl, isopropyl, butyl, isobutyl, tert-butyl, pentyl, neopentyl, hexyl, thexyl, fluorine, chlorine, bromine, sulfone or CN.

26. A process for stabilizing colorants based on anthraquinone and having at least one free hydroxyl function in the compounding of polycarbonate compositions which comprises utilizing tris-2-ethylhexyl phosphate (TOF).

27. A molding produced using one of the compositions as claimed in claim 16.

28. The molding as claimed in claim 27, wherein the composition is an automobile window.

29. A multilayer product comprising:
a) a substrate layer consisting of the composition as claimed in claim 16, and
b) at least one covering layer as antiscratch layer.

30. The multilayer product as claimed in claim 29, wherein the layer b) additionally comprises a UV protection layer.
